(19) United States
(12) Patent Application Publication
(10) Pub. No.: US 2012/0128205 A1
(43) Pub. Date: May 24, 2012

(54) APPARATUS FOR PROVIDING SPATIAL CONTENTS SERVICE AND METHOD THEREOF

(75) Inventors: Seong-Ho LEE, Daejeon (KR); Jae-Chul KIM, Daejeon (KR); Yoon-Seop CHANG, Daejeon (KR); Kyung-Ok KIM, Daejeon (KR); Sung-Woong SHIN, Daejeon (KR); Chang-Rak YOON, Daejeon (KR); Hak-Cheol KIM, Daejeon (KR); Ki-Jung LEE, Daejeon (KR)

(73) Assignee: Electronics and Telecommunications Research Intstitute, Daejeon-city (KR)

(21) Appl. No.: 13/291,657

(22) Filed: Nov. 8, 2011

(30) Foreign Application Priority Data
Nov. 22, 2010 (KR) 10-2010-0116236

(51) Int. Cl. G06K 9/00

(52) U.S. Cl. 382/103

(57) ABSTRACT

Disclosed herein is an apparatus for providing spatial contents service which includes a spatial contents insertion unit, a spatial contents generation unit, a topological relationship generation unit, and a spatial contents composition unit. The spatial contents insertion unit extracts spatial objects included in an image. The spatial contents generation unit generates primary spatial contents corresponding to the image. The topological relationship generation unit compares spatial location information of the primary spatial contents with spatial location information of one or more pieces of secondary spatial contents, and defines a spatial topological relationship between the primary spatial contents and the secondary spatial contents. The spatial contents composition unit couples or links the secondary spatial contents, which has a spatial topological relationship with the primary spatial contents, to the primary spatial contents.

### CROSS REFERENCE TO RELATED APPLICATION

This application claims the benefit of Korean Patent Application No. 10-2010-0116236, filed on Nov. 22, 2010, which is hereby incorporated by reference in its entirety into this application.

### BACKGROUND OF THE INVENTION

1. Technical Field

The present invention relates generally to an apparatus for providing spatial contents service and method, and, more particularly, to an apparatus for providing spatial contents service and method which extracts one or more spatial objects included in an image, and generates and provides digital spatial information contents in which spatial information about the corresponding spatial objects and various types of explanatory data are included in a digital image.

2. Description of the Related Art

Recently, digital photographing apparatuses, such as a digital camera and a camcorder, have been combined with a GPS (Global Positioning System) reception apparatus, a digital compass, and various types of sensors, and then produced and popularized. Pictures photographed using a digital camera combined with a GPS reception apparatus may be interworked with a map service and then uploaded using a picture sharing community such as Flickr or Panoramio.

As various types of contents including pictures and videos are shared via the Internet, the addition and exchange of the different opinions and annotations for each image included in the corresponding contents have become possible.

That is, instead of simple pictures and videos, composition contents including data which can be used to obtain spatial information from the contents itself has been generated.

### SUMMARY OF THE INVENTION

Accordingly, the present invention has been made keeping in mind the above problems occurring in the prior art, and an object of the present invention is to provide a method for adding additional spatial information used to increase the value of contents to a picture or video which includes location and direction information, and an apparatus for providing spatial contents service and method which analyzes the spatial topological relationships between contents and blends and compounds the contents together.

In order to accomplish the above object, the present invention provides an apparatus for providing spatial contents service, including: a spatial contents insertion unit for extracting one or more spatial objects included in an image in such a way as to perform filtering on the image and space of the image based on a predetermined filter setting value, and then inserting information about each of the spatial objects into the image; a spatial contents generation unit for generating primary spatial contents corresponding to the image in such a way as to load a previously registered spatial contents model and then include the information about each of the spatial objects corresponding to the structure of the spatial contents model in the spatial contents model; a topological relationship generation unit for comparing spatial location information of the primary spatial contents with spatial location information of one or more pieces of secondary spatial contents, and defining a spatial topological relationship between the primary spatial contents and the secondary spatial contents; and a spatial contents composition unit for coupling or linking the secondary spatial contents, which has a spatial topological relationship with the primary spatial contents, to the primary spatial contents.

Further, the apparatus for providing spatial contents service according to the present invention further includes a spatial index generation unit for generating a spatial index for the image based on the coordinate values of the image and/or the spatial objects.

The spatial index generation unit generates the spatial index based on information about a location and a direction in which the image was taken.

The topological relationship generation unit defines the spatial topological relationship based on the spatial index.

The topological relationship generation unit defines a spatial topological relationship between the pieces of secondary spatial contents included in the primary spatial contents or overlapping with the primary spatial contents.

Meanwhile, the apparatus for providing spatial contents service according to the present invention further including a filter setting unit for setting one or more filters used to extract the spatial objects included in the input image.

A filter setting value includes an image filter setting value and a spatial filter setting value; the image filter setting value includes a filter setting value for at least one of a road sign, a building, a face and a license plate, and includes filter selection information; and the spatial filter setting value includes filter selection information used to calculate at least one of a coordinate value of the image, and relative coordinate and absolute coordinate values of each of the spatial objects included in the image.

The spatial contents generation unit generates a Mark-up Language (XML)-type document corresponding to the structure of the spatial contents model, and includes the information about each of the spatial objects in the spatial contents model based on the structure of the document.

In order to accomplish the above object, the present invention provides a spatial contents service provision method, including: extracting one or more spatial objects included in an image in such a way as to perform filtering on the image and space of the image based on a predetermined filter setting value, and then inserting information about each of the spatial objects into the image; generating primary spatial contents corresponding to the image in such a way as to load a previously registered spatial contents model and then include the information about each of the spatial objects corresponding to the structure of the spatial contents model in the spatial contents model; comparing spatial location information of the primary spatial contents with spatial location information of one or more pieces of secondary spatial contents, and defines a spatial topological relationship between the primary spatial contents and the secondary spatial contents; and coupling or linking the secondary spatial contents, which has a spatial topological relationship with the primary spatial contents, to the primary spatial contents.

Further, the method of providing spatial contents service further includes generating a spatial index for the image based on coordinate values of the image and/or the spatial objects.

The generating the spatial index includes generating the spatial index based on information about a location and a direction in which the image was taken.

The defining the spatial topological relationship includes defining the spatial topological relationship based on the spatial index.

The defining the spatial topological relationship includes defining a spatial topological relationship between the pieces of secondary spatial contents included in the primary spatial contents or overlapping with the primary spatial contents.

Meanwhile, the method of providing spatial contents service according to the present invention further includes setting one or more filters used to extract the spatial objects included in the input image.

Here, a filter setting value includes an image filter setting value and a spatial filter setting value; the image filter setting value includes a filter setting value for at least one of a road sign, a building, a face and a license plate, and includes filter selection information; and the spatial filter setting value includes filter selection information used to calculate at least one of a coordinate value of the image, and relative coordinate and absolute coordinate values of each of the spatial objects included in the image.

The generating the spatial contents includes: generating an XML-type document corresponding to the structure of the spatial contents model; and including the information about each of the spatial objects in the spatial contents model based on the structure of the document.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating the configuration of an apparatus for providing spatial contents service according to the present invention;

FIG. 2 is a block diagram illustrating the detailed configuration of the storage unit of the apparatus for providing spatial contents service according to the present invention;

FIG. 3 is a block diagram illustrating the detailed configuration of the spatial contents insertion unit of the apparatus for providing spatial contents service according to the present invention;

FIGS. 4 to 9 are views illustrating the operation of the apparatus for providing spatial contents service according to the present invention;

FIG. 10 is a flowchart illustrating the operational flow of a method of providing spatial contents service according to the present invention.

FIG. 11 is a flowchart illustrating the detailed operational flow of the image input step of FIG. 10;

FIG. 12 is a flowchart illustrating the detailed operational flow of the spatial contents generation step of FIG. 10;

FIG. 13 is a flowchart illustrating the detailed operational flow of the spatial contents management step of FIG. 10; and

FIG. 14 is a flowchart illustrating the detailed operational flow of the spatial contents provision step of FIG. 10.

### DESCRIPTION OF THE PREFERRED EMBODIMENTS

Embodiments of the present invention will be described with reference to the accompanying drawings below.

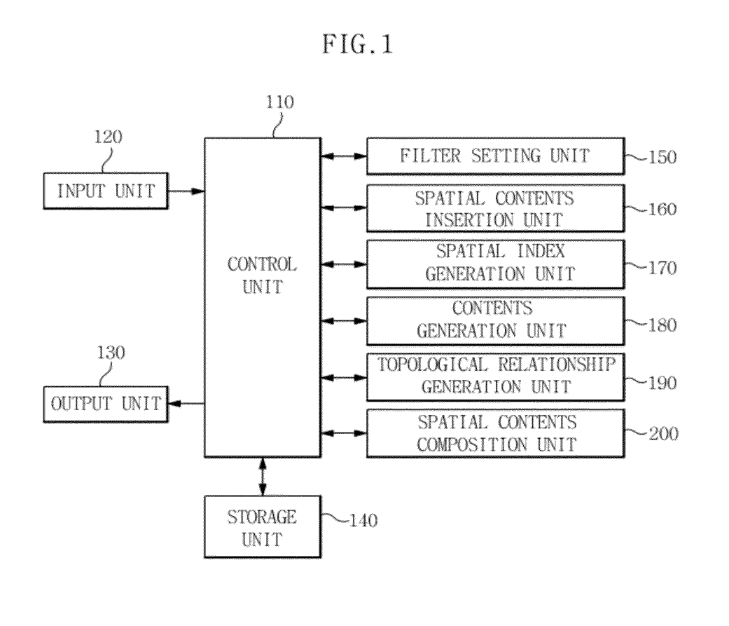

FIG. 1 is a block diagram illustrating the configuration of an apparatus for providing spatial contents service according to the present invention.

As shown in FIG. 1, the apparatus for providing spatial contents service according to the present invention includes a control unit 110, an input unit 120, an output unit 130, a storage unit 140, a filter setting unit 150, a spatial contents insertion unit 160, a spatial index generation unit 170, a contents generation unit 180, a topological relationship generation unit 190, and a spatial contents composition unit 200. Here, the control unit 110 controls the operations of the respective units of the apparatus for providing spatial contents service.

The input unit 120 is means for receiving images photographed using a camera. Here, each of the images received using the input unit 120 may correspond to an image which includes location information (GPS information) and a heading angle, an image which does not include the location information nor the heading angle, or a video or a panorama image which includes GPS Exchange Format (GPX), that is, the log information of GPS.

Further, the input unit 120 performs the operation of analyzing the meta information of a corresponding image in order to determine the type of information included in the received image.

The output unit 130 is means for providing a spatial contents service requested by a user, and is used to output spatial contents that is the final result generated using the spatial contents composition unit 200 as well as to display a screen which displays the operation of the apparatus for providing spatial contents service.

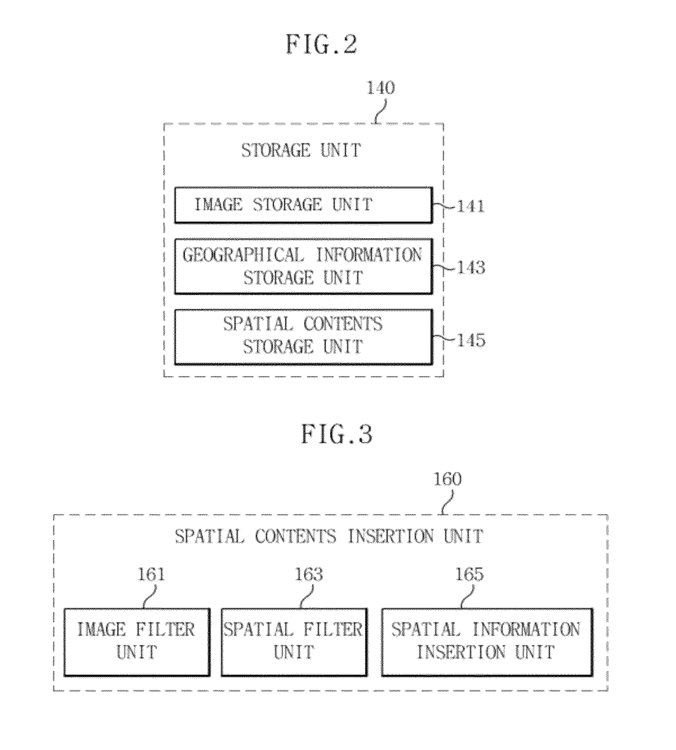

The storage unit 140 stores images received using the input unit 120 and also stores the meta information of each of the images that were analyzed using the input unit 120. In addition, the storage unit 140 stores data resulting from the operations of the filter setting unit 150, the spatial contents insertion unit 160, the spatial index generation unit 170, the contents generation unit 180, the topological relationship generation unit 190, and the spatial contents composition unit 200. The configuration of the storage unit 140 will be described in detail with reference to an embodiment shown in FIG. 2.

The filter setting unit 150 sets filter values used to extract one or more spatial objects included in each image received using the input unit 120. Here, the filter setting unit 150 sets an image filter value and a spatial filter value.

Here, the image filter setting value is indicative of the extraction/non-extraction of a road sign, a building (the appearance of the building and each floor of the building), the face of a human and a license plate, and includes corresponding filter (library) selection information. Further the spatial filter setting value includes corresponding filter (library) selection information used to calculate the coordinate values of an image itself, the relative coordinate and absolute coordinate values of each of the spatial objects which exist in the corresponding image.

In addition, the filter setting unit 150 determines whether a user manually performs spatial filtering and image filtering or whether extraction is automatically performed.

The spatial contents insertion unit 160 performs operations of extracting one or more spatial objects from the received image and blending information about each of the spatial objects with the corresponding image. The configuration of the spatial contents insertion unit 160 will be described in detail with reference to an embodiment shown in FIG. 3.

The spatial index generation unit 170 generates a spatial index using the coordinate value of each of the spatial objects extracted from the received image. Here, a general spatial index, such as “R-tree”, may be used as the spatial index for the coordinate value of each of the spatial objects.

Further, the spatial index generation unit 170 generates a spatial index for an image itself. Here, the spatial index for an image itself includes the location of a digital photographing apparatus that a photograph was taken from, a figure (a fan shape in the case of 2 dimensions or a quadrangular pyramid shape in the case of 3 dimensions) made using an image which is focused on a lens, and directional information about the direction the photograph was taken in. Here, the spatial index generated using a figure (a fan shape or a quadrangular pyramid shape) which includes the directional information may be used to search for contents which can be viewed from a specific location in the real world.

In addition, the spatial index generated using the figure (a fan shape or a quadrangular pyramid shape) which includes the directional information may be extended in such a way as to include directional information in a spatial relationship operator DE-9IM (Disjoint, Touches, Crosses, Within, Overlaps, Contains, or Intersects). Therefore, the apparatus for providing spatial contents service may provide contents which are suitable for a user situation (a location and a direction).

The contents generation unit 180 loads a previously registered spatial contents model and generates an Extended Mark-up Language (XML)-type document structure suitable for the corresponding spatial contents model. Further, the contents generation unit 180 generates spatial contents in such a way as to include information about each of the spatial objects inserted into a corresponding image in the corresponding spatial contents model based on the document structure.

Here, the document structure may be stored in the form of a reference-type independent file or in the form of being embedded in spatial contents.

The topological relationship generation unit 190 defines the topological relationship between a plurality of pieces of spatial contents which were generated using the contents generation unit 180. That is, the topological relationship generation unit 190 defines a relationship, which is indicative of whether a single image is included in another image or whether a single image intersects another image or not, that is, a topological relationship between the plurality of pieces of spatial contents, using the spatial indexes.

For example, if it is assumed that a single image corresponds to the specific area of another image that was photographed, the two images may spatially have a topological relationship.

The spatial contents composition unit 200 provides composition functions of coupling the pieces of spatial contents which have a topological relationship and linking them in such a way as to overlap the pieces of spatial contents based on the topological relationship between the pieces of spatial contents defined using the topological relationship generation unit 190.

FIG. 2 is a block diagram illustrating the detailed configuration of the storage unit 140 of the apparatus for providing spatial contents service according to the present invention.

As shown in FIG. 2, the storage unit 140 includes an image storage unit 141, a geographical information storage unit 143, and a spatial contents storage unit 145.

First, the image storage unit 141 stores images received using the input unit 120 and a plurality of pieces of meta information corresponding to the respective images. Further, the image storage unit 141 may store a plurality of pieces of information about the respective spatial objects included in each of the images and filter setting values corresponding to the respective spatial objects.

The geographical information storage unit 143 stores a plurality of pieces of geographical information about locations and angles in which the respective images received using the input unit 120 were taken.

The spatial contents storage unit 145 stores a plurality of pieces of spatial contents generated using the contents generation unit 180. Further, the spatial contents storage unit 145 stores the spatial indexes corresponding to the respective spatial contents and the topological relationship between the pieces of spatial contents. Further, the spatial contents storage unit 145 may separately store a plurality of pieces of spatial contents on which composition is performed based on the stored a topological relationship between the pieces of spatial contents.

FIG. 3 is a block diagram illustrating the detailed configuration of the spatial contents insertion unit 160 of the apparatus for providing spatial contents service according to the present invention.

As shown in FIG. 3, the spatial contents insertion unit 160 includes an image filter unit 161, a spatial filter unit 163, and a spatial information insertion unit 165.

First, the image filter unit 161 extracts one or more spatial objects included in an image based on the image filter setting value set using the filter setting unit 150. Here, the spatial objects extracted using the image filter unit 161 may include a building (the appearance of the building and the floor of the building), a road sign, the face of a human, and a license plate. Further, the image filter unit 161 assigns a unique Identification (ID), geometry, a coordinate value, and annotation for each of the extracted spatial objects.

The spatial filter unit 163 calculates a spatial attribute value for each of the spatial objects extracted using the image filter unit 161 and assigns the spatial attribute value thereto. Here, the spatial filter unit 163 uses meta data, such as information about a location, a direction and an angle of view at which the image was photographed, as parameters, searches the geographical information for the attribute information about one or more spatial objects corresponding to a line of sight, and then assigns annotations to the respective spatial objects.

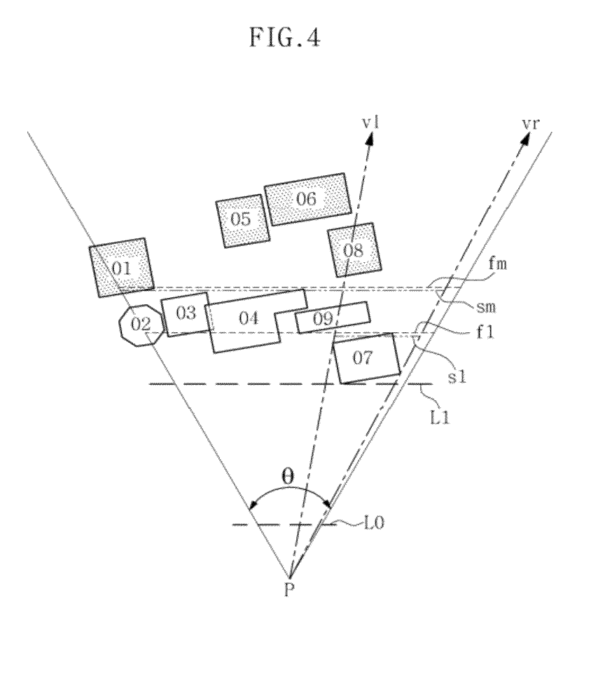

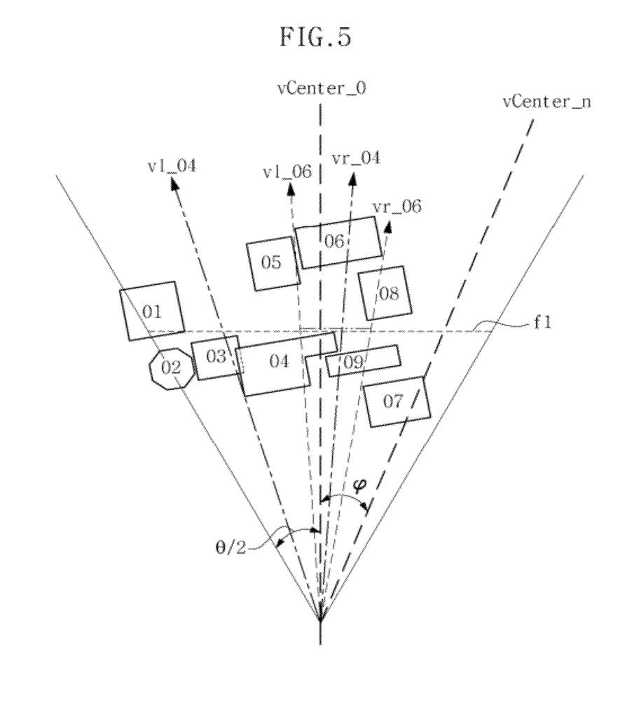

Here, the attribute information about each of the spatial objects may provide one or more incorrect candidate values depending on the accuracy of the parameters and the existence/non-existence of the parameters. The extraction of attribute information about each of the spatial objects may be realized using methods shown in FIGS. 4 and 5. The candidate values may be selected and adjusted using the spatial information insertion unit 165.

When the face of a human or a license plate is veiled in the corresponding image, the spatial information insertion unit 165 may substitute another image (content) for annotation. That is, the type of annotation for each of the extracted spatial objects may include video, audio, an image, text, geometry, and a Universal Resource Locator (URL).

Further, the spatial information insertion unit 165 is means for selecting annotation values and candidate values, assigned to the respective spatial objects using the image filter unit 161 and the spatial filter unit 163, and then integrating them. The spatial information insertion unit 165 is used to integrate filtered spatial attributes and image attributes into the corresponding image or used to enable a user to perform functions which can be selected from among the candidate values.

FIGS. 4 to 8 are views illustrating the operations of the apparatus for providing spatial contents service according to the present invention.

First, FIG. 4 illustrates an embodiment of an operation of extracting spatial objects using the apparatus for providing spatial contents service according to the present invention.

As shown in FIG. 4, the figures of spatial objects O1 to O9 which exist within the angle of view θ of a camera are formed on an image photographed using a camera.

Here, the spatial contents insertion unit 160 moves lines L0 and L1, which are perpendicular to the direction in which the image was taken, to a distance that is a long ways from an origin point P, and searches for spatial objects which intersect the lines. The spatial contents insertion unit 160 may search for spatial objects using a method such as a plane sweep algorithm.

For example, the spatial contents insertion unit 160 finds the spatial object O7 using the line L1, and then obtains the geometry of the spatial object O7 and the extensions v1 and vr of lines made when the origin point P meets the largest right and left side vertexes of the spatial object O7.

Thereafter, the spatial contents insertion unit 160 can be aware that a line, made when the extensions v1 and vr meet a photosensitive surface f1 on which the figure of the spatial object O7 is formed, corresponds to a section on which an image is actually taken.

As described above, when the line L1 is horizontally moved a distance away, other objects may be extracted. Further, objects which exist between specific angles can be obtained on a photosensitive surface on which one or more figures are actually formed.

Here, the spatial contents insertion unit 160 determines the distribution of spatial objects on the photosensitive surface f1 or fm, or determines the distance from the origin point P to the spatial objects which will be extracted based on a distance defined by a user.

In FIG. 4, if the objects O7, O4, O2, O3, and O9 are sequentially extracted, the spatial objects whose figures are formed on the photosensitive surface fm form a single projection surface sm. Here, when the area ratio of fm to sm reaches a threshold which is systematically set by a user or a manager, the spatial contents insertion unit 160 stops the plane sweeping.

FIG. 5 illustrates another embodiment of an operation of extracting spatial objects using the apparatus for providing spatial contents service according to the present invention.

As shown in FIG. 5, the spatial contents insertion unit 160 may extract one or more spatial objects which intersect the central line vCenter_0 of a heading angle, and may detect lines corresponding to the extracted spatial objects whose figures are formed on the photosensitive surface f1 as in the method shown in FIG. 4.

Thereafter, the spatial contents insertion unit 160 performs the plane sweeping based on the central line vCenter_0 from side to side at predetermined angles. In this method, a single point Q is fixed.

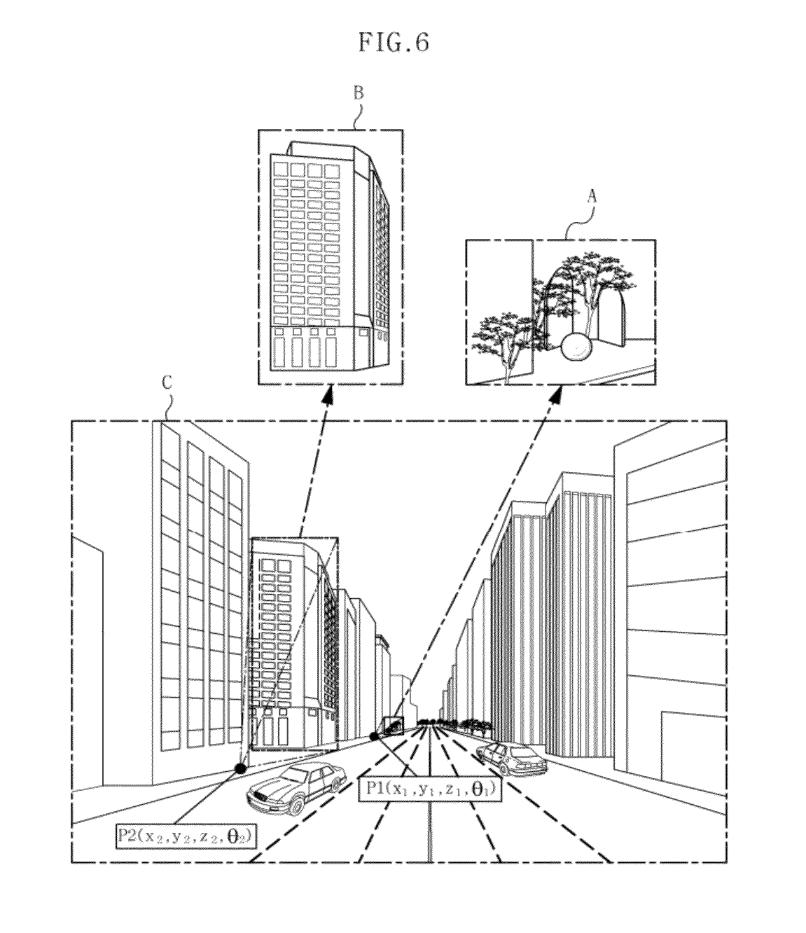

FIG. 6 illustrates an embodiment in which a single spatial contents includes one or more pieces of other spatial contents.

First, reference character C indicates a single piece of spatial contents, and reference characters A and B indicate respective pieces of spatial contents for specific geometries which are included in the spatial contents C and are different from each other.

Here, the spatial filter unit 163 may assign the spatial objects A and B, which are extracted from the input image of the spatial contents C, to the annotation of the spatial contents C. Further, the spatial filter unit 163 may assign the attribute information about spatial objects, which are relevant to the respective pieces of spatial contents A and B, to the annotation of the spatial contents C.

In addition, since the spatial contents A photographed at the location P1 of the spatial contents C and the spatial contents B photographed at the location P2 are included in the spatial contents C as the spatial objects, a topological relationship is made between the spatial contents A, B, and C. Therefore, the topological relationship generation unit 190 may defines the topological relationship between the spatial contents A, B, and C using the spatial indexes of the respective pieces of the spatial contents A and B.

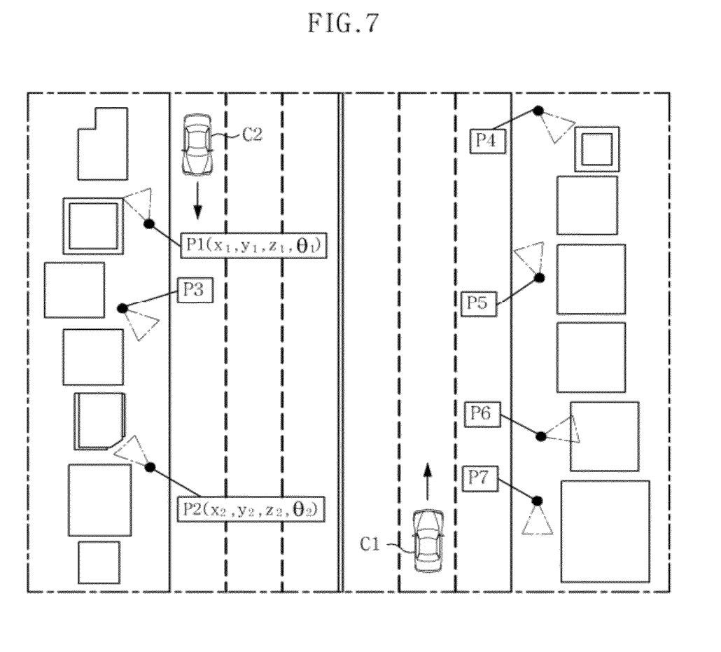

FIG. 7 is a view illustrating a 2-dimensional image relevant to FIG. 6, in particular, illustrating a spatial index relevant to the spatial contents C.

As shown in FIG. 7, it can be known that the spatial contents C includes a plurality of pieces of sub spatial contents photographed at P1 to P7, and that there is a topological relationship between the spatial contents C and the plurality of pieces of sub spatial contents. Here, each piece of the sub spatial contents includes a spatial index having information about a location and a direction in which the corresponding sub spatial contents was taken, and only one or more pieces of spatial contents corresponding to the location of a user and the direction in which the user is moving can be searched for using the spatial indexes of the respect pieces of sub spatial contents.

For example, in FIG. 7, the sub spatial contents photographed at P1, P2, and P5, and P6 corresponds to spatial contents which can be viewed when a vehicle C1 moves forward, so that the sub spatial contents photographed at P1, P2, and P5, and P6 can be extracted and then provided to the vehicle C1.

Meanwhile, the sub spatial contents photographed at P3, P4, and P7 corresponds to spatial contents which can be viewed when a vehicle C2 moves forward, so that the sub spatial contents photographed at P3, P4, and P7 can be extracted and then provided to the vehicle C2.

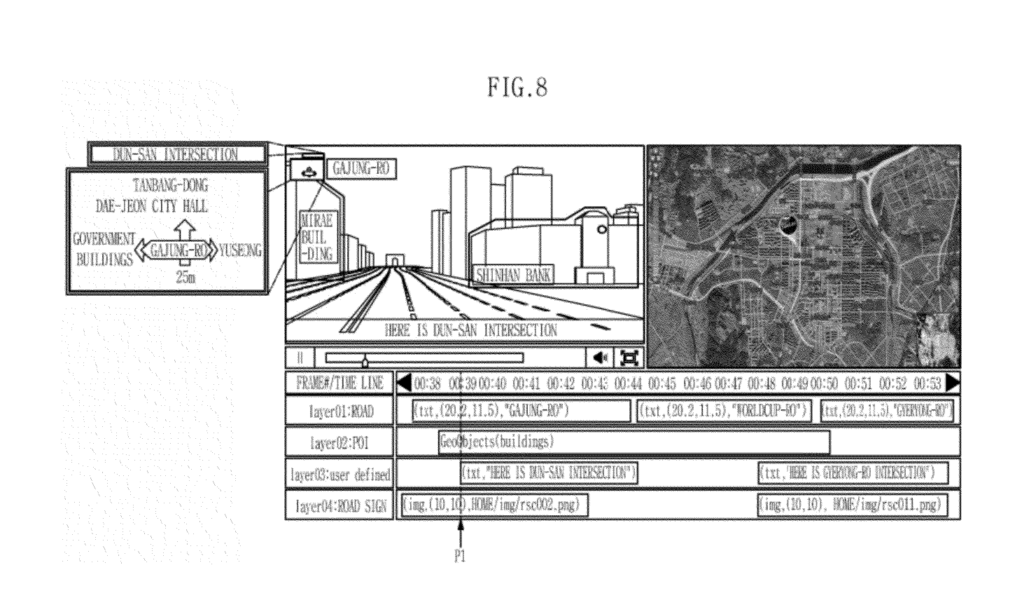

FIG. 8 illustrates an embodiment in which annotation is assigned to each of spatial objects included in a video.

The spatial contents insertion unit 160 may assign spatial attribute information or image attribute information to each of extracted spatial objects as annotation. Here, FIG. 8 illustrates an embodiment relevant to various types of annotation, including text, an image, a URL, video, and other spatial contents, at the corresponding position and for a predetermined time of each frame.

The annotation may be assigned for each of multiple layers based on the type and character thereof.

As shown in FIG. 8, in the case of a layer 01, for the respective frames of an image, road names corresponding to the respective frames, for example, “Gajung-ro”, “Worldcup-ro”, and “Gyeryong-ro” are assigned as annotation. In the case of layer 02, information about spatial objects for one or more buildings included in each frame, for example, the names of buildings are assigned as annotation. In the case of layer 03, information about a current location for each frame, for example, “Here is Dun-san intersection” or “Here is Gyeryong-ro intersection” is assigned as annotation. In the case of layer 04, a road sign image is assigned as annotation.

Since the playback time point of a corresponding image is currently located at a time point P1, the respective annotations of layers 01, 02, 03, and 04 (layer 01:“Gajung-ro”, layer 02: information about spatial objects, layer 03: “Here is Dun-san intersection.”, and layer 04: rsc002.png) assigned at the current time point are displayed together.

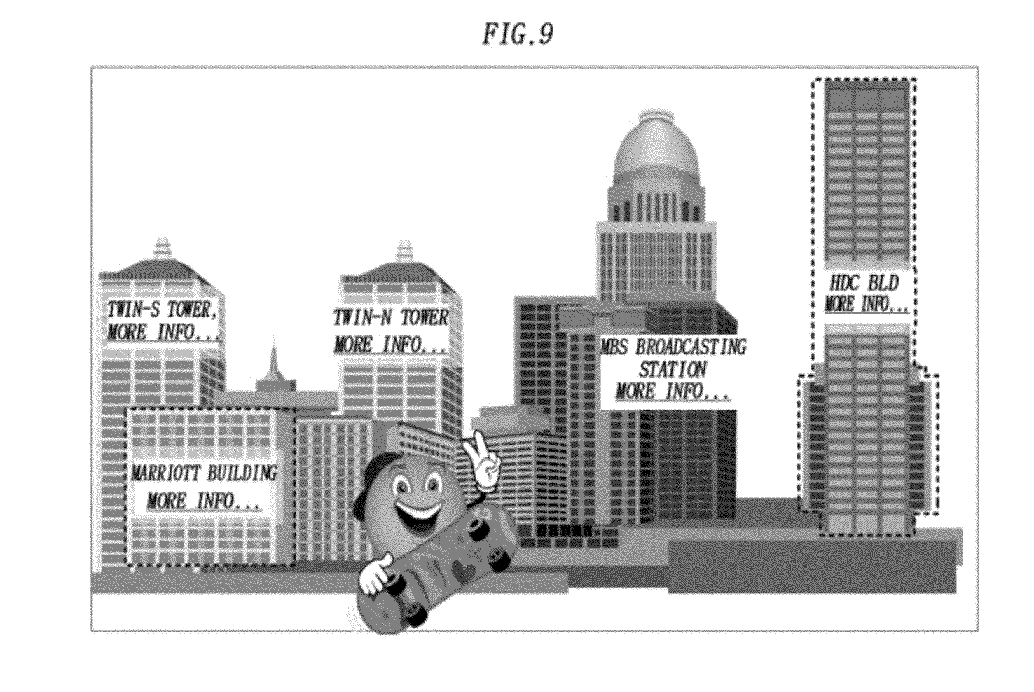

FIG. 9 illustrates an embodiment of the assignment of a plurality of annotations to respective spatial objects included in an image.

As shown in FIG. 9, the spatial objects included in a still image, for example, Twin-S tower, Twin-N tower, Marriott building, MBS broadcasting station and HDC BLD are displayed together with attribute information relevant to the respective spatial objects as annotation.

The operation of a method of providing spatial contents service according to the present invention configured as described above will be described in detail below.

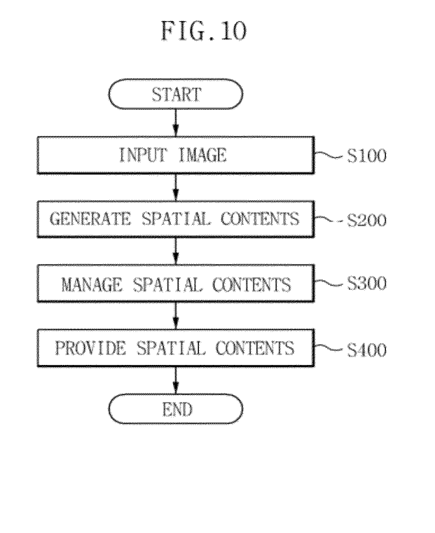

FIG. 10 illustrates the entire operational flow of the method of providing spatial contents service according to the present invention.

As shown in FIG. 10, the method of providing spatial contents service according to the present invention may be explained using an image input step (S100), a spatial contents generation step (S200), a spatial contents management step (S300), and a spatial contents provision step (S400).

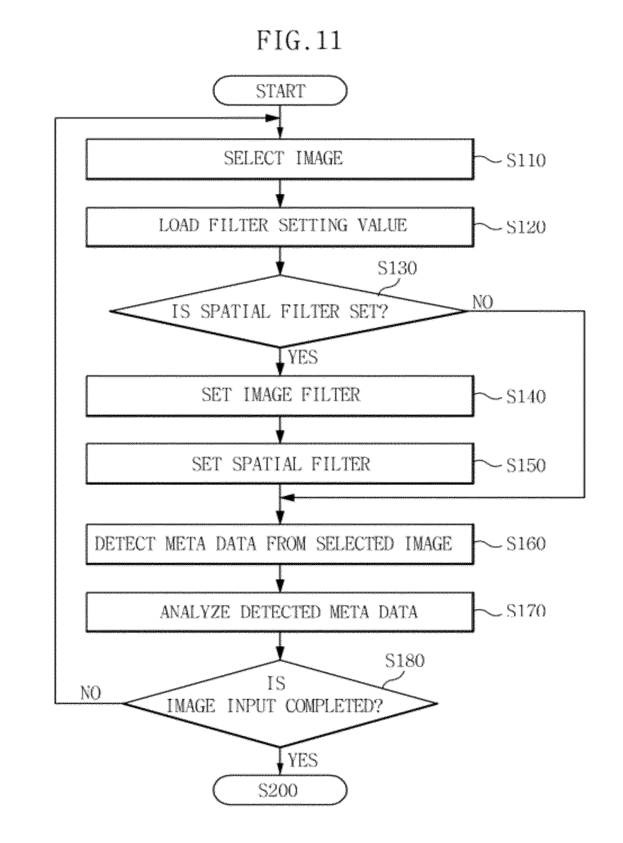

The detailed operational flow for each step will be described with reference to FIGS. 11 to 14.

First, FIG. 11 illustrates the detailed operational flow of the image input step of FIG. 10.

As shown in FIG. 11, when an input image is selected at step S110, the apparatus for providing spatial contents service according to the present invention loads the filter setting value of the corresponding image at step S120.

If the filter setting value of the corresponding image does not exist and it is necessary to set a spatial filter and an image filter for the corresponding image at step S130, the spatial filter and the image filter are set at steps S140 and S150. Here, the set image filter setting value and spatial filter setting value are stored in the storage unit 140.

It is apparent that, if established filter setting values existed and they were loaded at step S120, the spatial and image filter setting steps are omitted.

Thereafter, the apparatus for providing spatial contents service detects meta data from the selected image at step S160 and then analyzes the detected meta data at step S170.

If the input of the selected image is completed at step S180, the following step S200 is performed. Otherwise, the process returns to step S110 and then the steps are performed again.

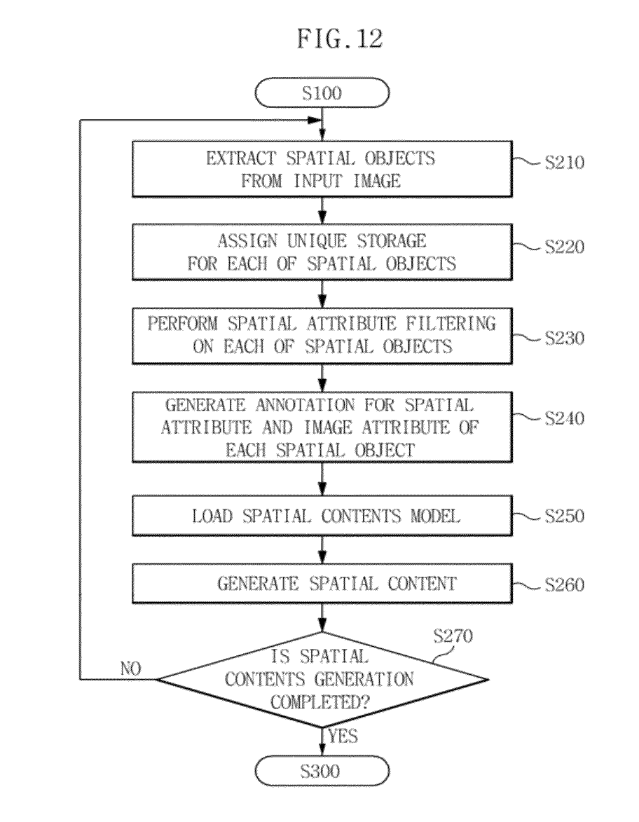

FIG. 12 illustrates the detailed operational flow of the spatial contents generation step of FIG. 10.

As shown in FIG. 12, when the image is received at step S100, the apparatus for providing spatial contents service according to the present invention extracts one or more spatial objects from the received image at step S210 and then assigns unique storage for each of the spatial objects at step S220.

Thereafter, the apparatus for providing spatial contents service filters spatial attributes and image attributes based on the attribute filter values of the respective spatial objects at step S230, and then generates annotation for the spatial attribute and image attribute of each of the spatial objects at step S240.

Further, the apparatus for providing spatial contents service loads a spatial contents model at step S250, and then generates spatial contents in such a way as to include the spatial attribute, the image attribute, and the annotation in the corresponding spatial contents model at step S260.

If the generation of the spatial contents has not completed or it is necessary to generate spatial contents for a new input image at step S270, the apparatus for providing spatial contents service generates spatial contents in such a way as to perform the steps at S210 to S260.

Meanwhile, when the generation of the spatial contents is completed at step S270, the apparatus for providing spatial contents service terminates the spatial contents generation step and then performs the following step S300.

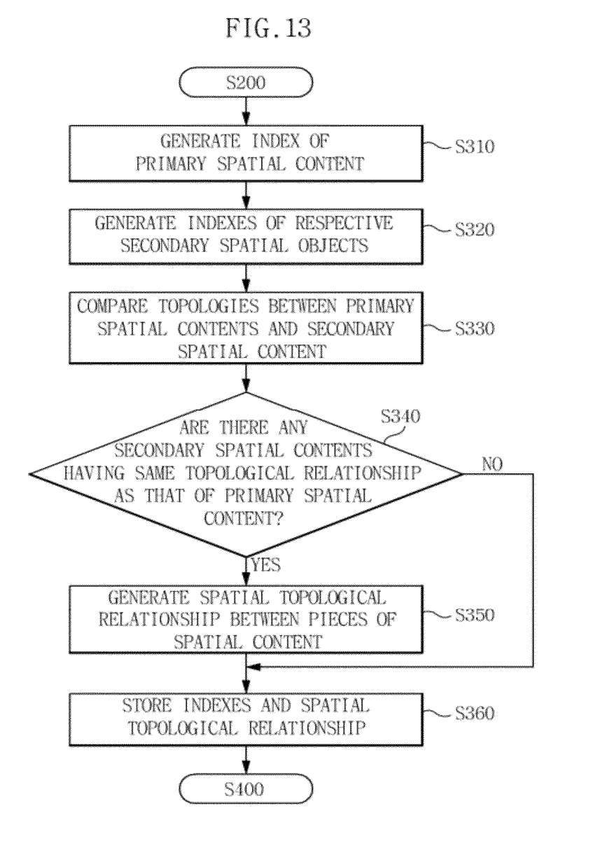

FIG. 13 illustrates the detailed operational flow of the spatial contents management step of FIG. 10.

As shown in FIG. 13, the apparatus for providing spatial contents service generates an index for primary spatial contents (generated at step S200) at step S310, and then generates indexes for one or more secondary spatial objects included in the primary spatial contents at step S320.

Thereafter, the apparatus for providing spatial contents service compares the topologies thereof based on the index of the primary spatial contents and the indexes of the pieces of secondary spatial contents at step S330.

The secondary spatial contents may be any other spatial contents except the primary spatial contents.

If there are one or more pieces of secondary spatial contents having the same topological relationship as that of the primary spatial contents at step S340, the apparatus for providing spatial contents service generates a spatial topological relationship between the corresponding pieces of spatial contents at step S350.

The apparatus for providing spatial contents service stores the indexes, generated for the corresponding pieces of spatial contents, and the spatial topological relationship thereof in the storage unit 140 at step S360, and then performs the step S400. It is apparent that, when a topological relationship is not made between the corresponding primary spatial contents and the secondary spatial contents, only the index generated for the primary spatial contents is stored.

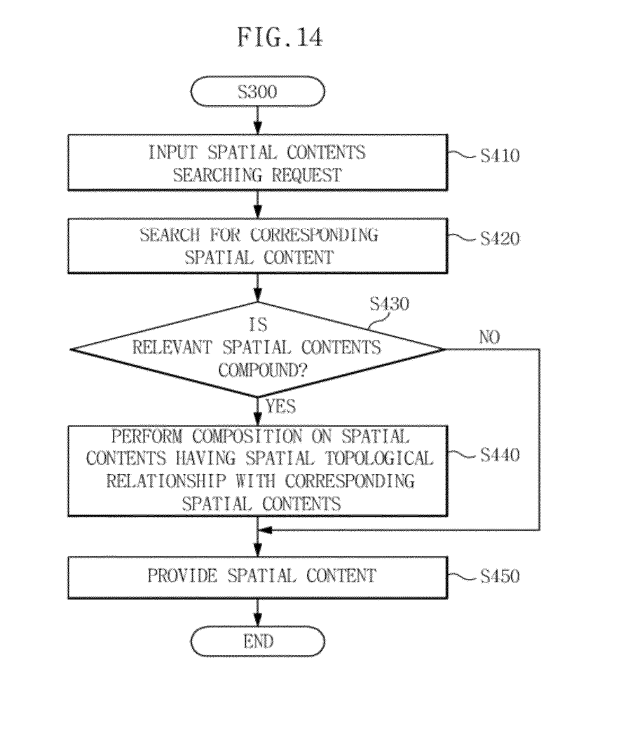

FIG. 14 illustrates the detailed operational flow of the spatial contents provision step of FIG. 10.

As shown in FIG. 14, when a spatial contents searching request is received from a user at step S410, the apparatus for providing spatial contents service searches for the corresponding spatial contents at step S420.

Here, when it is necessary to compound one or more pieces of spatial contents which are relevant to the found spatial contents at step S430, the apparatus for providing spatial contents service compounds the relevant spatial contents with the corresponding spatial contents based on the spatial topological relationship of the corresponding spatial contents at step S440, and then provides the resulting spatial contents to the user at step S450.

Meanwhile, if the user does not want to compound one or more pieces of spatial contents which are relevant to the corresponding spatial contents or spatial contents which is relevant to the corresponding spatial contents does not exist, the apparatus for providing spatial contents service provides the spatial contents found at step S420 to the user at step S450.

According to the present invention, a plurality of pieces of digital spatial contents is generated in such a way as to include spatial information in each of digital images photographed using a digital camera or a camcorder and in various types of objects which are included in each of the digital images, and a topological relationship is made between the spatial contents, so that there is an advantage of searching for and providing spatial contents which is suitable for a user location and situation as well as an existing simple map service in which pictures and video are interworked with a map.

Further, the present invention has an advantage of increasing the meaning and value of the main contents of navigation and augmented reality service.

As described above, the apparatus for providing spatial contents service and method according to the present invention has been described with reference to the exemplified drawings, the present invention is not limited to the embodiments and drawings disclosed in the present specification and those skilled in the art will appreciate that various modifications, additions and substitutions are possible, without departing from the scope and spirit of the invention as disclosed in the accompanying claims.

What is claimed is:

1. An apparatus for providing spatial contents service, comprising:
a spatial contents insertion unit for extracting one or more spatial objects included in an image by performing filtering on the image and space of the image based on a predetermined filter setting value, and then inserting information about each of the spatial objects into the image;
a spatial contents generation unit for generating primary spatial contents corresponding to the image by loading a previously registered spatial contents model and then making information about each of the spatial objects corresponding to a structure of the spatial contents model be included in the spatial contents model;
a topological relationship generation unit for comparing spatial location information of the primary spatial contents with spatial location information of one or more pieces of secondary spatial contents, and defining a spatial topological relationship between the primary spatial contents and the secondary spatial contents; and
a spatial contents composition unit for linking the secondary spatial contents, which has a spatial topological relationship with the primary spatial contents, to the primary spatial contents.

2. The apparatus for providing spatial contents service as set forth in claim 1, further comprising a spatial index generation unit for generating a spatial index for the image based on coordinate values of the image and/or the spatial objects.

3. The apparatus for providing spatial contents service as set forth in claim 2, wherein the spatial index generation unit generates the spatial index based on information about a location and a direction in which the image was taken.

4. The apparatus for providing spatial contents service as set forth in claim 2, wherein the topological relationship generation unit defines the spatial topological relationship based on the spatial index.

5. The apparatus for providing spatial contents service as set forth in claim 1, wherein the topological relationship generation unit defines a spatial topological relationship between the pieces of secondary spatial contents included in the primary spatial contents or overlapping with the primary spatial contents.

6. The apparatus for providing spatial contents service as set forth in claim 1, further comprising a filter setting unit for setting one or more filters used to extract the spatial objects included in the input image.

7. The apparatus for providing spatial contents service as set forth in claim 1, wherein:
the predetermined filter setting value includes an image filter setting value and a spatial filter setting value;
the image filter setting value includes a filter setting value for at least one of a road sign, a building, a face and a license plate, and includes filter selection information; and
the spatial filter setting value includes filter selection information used to calculate at least one of a coordinate value of the image, and relative coordinate and absolute coordinate values of each of the spatial objects included in the image.

8. The apparatus for providing spatial contents service as set forth in claim 1, wherein the spatial contents generation unit generates a Mark-up Language (XML)-type document corresponding to the structure of the spatial contents model, and includes the information about each of the spatial objects in the spatial contents model based on the structure of the document.

9. A method of providing spatial contents service, comprising:
extracting one or more spatial objects included in an image by performing filtering on the image and space of the image based on a predetermined filter setting value and then inserting information about each of the spatial objects into the image;
generating primary spatial contents corresponding to the image by loading a previously registered spatial contents model and then making information about each of the spatial objects corresponding to a structure of the spatial contents model be included in the spatial contents model;
comparing spatial location information of the primary spatial contents with spatial location information of one or more pieces of secondary spatial contents, and defining a spatial topological relationship between the primary spatial contents and the secondary spatial contents; and
linking the secondary spatial contents, which has a spatial topological relationship with the primary spatial contents, to the primary spatial contents.

10. The method of providing spatial contents service as set forth in claim 9, further comprising generating a spatial index for the image based on coordinate values of the image and/or the spatial objects.

11. The method of providing spatial contents service as set forth in claim 10, wherein the generating the spatial index comprises generating the spatial index based on information about a location and a direction in which the image was taken.

12. The method of providing spatial contents service as set forth in claim 10, wherein the defining the spatial topological relationship comprises defining the spatial topological relationship based on the spatial index.

13. The method of providing spatial contents service as set forth in claim 9, wherein the defining the spatial topological relationship comprises defining a spatial topological relationship between the pieces of secondary spatial contents included in the primary spatial contents or overlapping with the primary spatial contents.

14. The method of providing spatial contents service as set forth in claim 9, further comprising setting one or more filters used to extract the spatial objects included in the input image.

15. The method of providing spatial contents service as set forth in claim 9, wherein:
the predetermined filter setting value includes an image filter setting value and a spatial filter setting value;
the image filter setting value includes a filter setting value for at least one of a road sign, a building, a face and a license plate, and includes filter selection information; and
the spatial filter setting value includes filter selection information used to calculate at least one of a coordinate value of the image, and relative coordinate and absolute coordinate values of each of the spatial objects included in the image.

16. The method of providing spatial contents service as set forth in claim 9, wherein the generating the spatial contents comprises:
generating an XML-type document corresponding to the structure of the spatial contents model; and
including the information about each of the spatial objects in the spatial contents model based on the structure of the document.
